(19) United States
(12) Patent Application Publication
(10) Pub. No.: US 2017/0346997 A1
(43) Pub. Date: Nov. 30, 2017

(54) VEHICLE CAMERA DEVICE

(71) Applicant: AISIN SEIKI KABUSHIKI KAISHA, Kariya-shi (JP)

(72) Inventors: Shigeki SATO, Anjo-shi (JP); Takayuki Fukuda, Ichinomiya-shi (JP); Tokuhiro Shiga, Obu-shi (JP); Kenji Hori, Toyota-shi (JP)

(73) Assignee: AISIN SEIKI KABUSHIKI KAISHA, Kariya-shi (JP)

(21) Appl. No.: 15/593,423

(22) Filed: May 12, 2017

(30) Foreign Application Priority Data
May 27, 2016 (JP) 2016-106440

(51) Int. Cl. H04N 5/225; B60R 11/04; B60R 1/00; B60S 1/62; H04N 5/232; G02B 27/00

(52) U.S. Cl. CPC H04N 5/2252; H04N 5/23296; H04N 5/23293; G02B 27/0006; B60R 1/00; B60S 1/62; B60R 11/04; B60R 2300/8066

(57) ABSTRACT

A vehicle camera device includes: a lid that opens and closes an opening of a camera accommodation chamber; a camera that is capable of being accommodated in the camera accommodation chamber and exposed from the opening when the opening is opened by a rotation of the lid; and a driving device that operates the camera and the lid, in which the camera has an image capturing posture when the camera captures an image of a portion below a reference axis, an accommodation posture when the camera is accommodated in the camera accommodation chamber, and the other postures different from the image capturing posture and the accommodation posture.

### CROSS REFERENCE TO RELATED APPLICATIONS

This application is based on and claims priority under 35 U.S.C. §119 to Japanese Patent Application 2016-106440, filed on May 27, 2016, the entire contents of which are incorporated herein by reference.

### TECHNICAL FIELD

This disclosure relates to a vehicle camera device for capturing an image of an exterior of a vehicle.

### BACKGROUND DISCUSSION

A technology disclosed in JP2001-058543A (Reference 1) is known as a vehicle camera device.

The vehicle camera device disclosed in Reference 1 includes a lid which is rotatably mounted in a vehicle and opens and closes an opening, and a camera which is mounted on the lid and accommodated in the vehicle when the lid closes the opening. When the lid rotates to open the opening, the camera is exposed from the opening.

By the way, the function of the vehicle camera device in the related art is restricted because the camera is retained only in a posture in which the camera captures an image of a lower side.

### SUMMARY

(1) A vehicle camera device according to an aspect of this disclosure includes: a lid that opens and closes an opening of a camera accommodation chamber; a camera that is capable of being accommodated in the camera accommodation chamber and exposed from the opening when the opening is opened by a rotation of the lid; and a driving device that operates the camera and the lid, in which the camera has an image capturing posture when the camera captures an image of a portion below a reference axis, an accommodation posture when the camera is accommodated in the camera accommodation chamber, and the other postures different from the image capturing posture and the accommodation posture.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view of a vehicle in which a vehicle camera device is mounted;

FIG. 2 is a perspective view of the vehicle camera device;

FIG. 3 is a front view of the vehicle camera device disposed in an accommodation posture;

FIG. 4 is a cross-sectional view of the vehicle camera device disposed in the accommodation posture;

FIG. 5 is a cross-sectional view of the vehicle camera device disposed in the accommodation posture;

FIG. 6 is a front view of the vehicle camera device disposed in a first image capturing posture;

FIG. 7 is a cross-sectional view of the vehicle camera device disposed in the first image capturing posture;

FIG. 8 is a cross-sectional view of the vehicle camera device disposed in the first image capturing posture;

FIG. 9 is a front view of the vehicle camera device disposed in a cleaning posture;

FIG. 10 is a cross-sectional view of the vehicle camera device disposed in the cleaning posture;

FIG. 11 is a cross-sectional view of the vehicle camera device disposed in the cleaning posture;

FIG. 12 is a cross-sectional view of the vehicle camera device disposed in a second image capturing posture;

FIG. 13 is a cross-sectional view of the vehicle camera device disposed in a third image capturing posture;

FIG. 14 is an explanatory view for explaining an example of use in the third image capturing posture;

FIG. 15 is a schematic view of a vehicle in which a vehicle camera device according to another exemplary embodiment is mounted; and

FIG. 16 is a flowchart illustrating a processing procedure of a foreign matter attachment detecting process.

### DETAILED DESCRIPTION

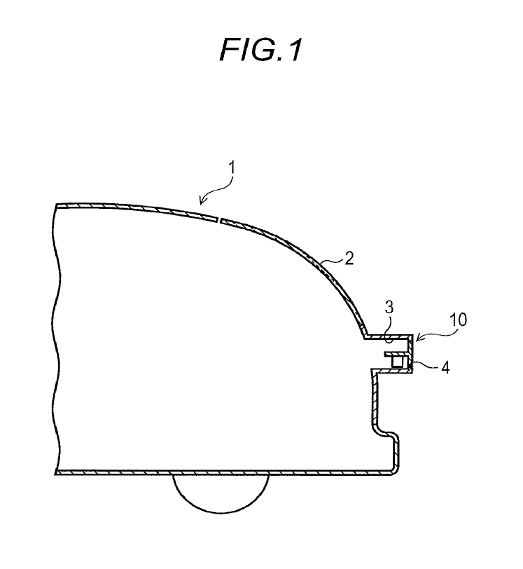

A vehicle camera device will be described with reference to FIGS. 1 to 14.

Regarding a vehicle camera device, a direction along a vertical direction in a state in which the vehicle camera device is installed in a vehicle is referred to as an “up and down direction” of the vehicle camera device, a direction along a vehicle width direction in a state in which the vehicle camera device is installed in the vehicle is referred to as a “width direction DX” of the vehicle camera device, and a direction along a front and rear direction of the vehicle in a state in which the vehicle camera device is installed in the vehicle is referred to as a “front and rear direction DY” of the vehicle camera device.

As illustrated in FIG. 1, for example, a vehicle camera device 10 is mounted at a rear side of a vehicle 1. The vehicle camera device 10 captures an image of an exterior of the vehicle. For example, the vehicle camera device 10 captures an image of an object at the rear side of the vehicle in order to allow an occupant to recognize image information of a road surface at the rear side, a following vehicle, an obstacle at the rear side, and an obstacle at a rear upper side. The information about images captured by the vehicle camera device 10 is transmitted to a display device mounted in the vehicle 1.

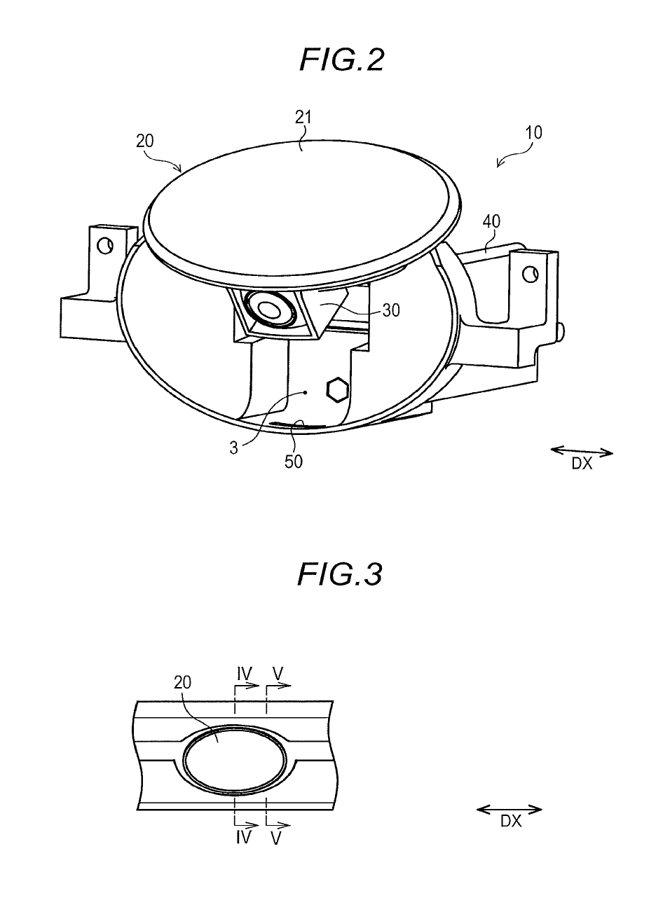

As illustrated in FIG. 2, the vehicle camera device 10 includes a lid 20, a camera 30, and a driving device 40 which operates the camera 30.

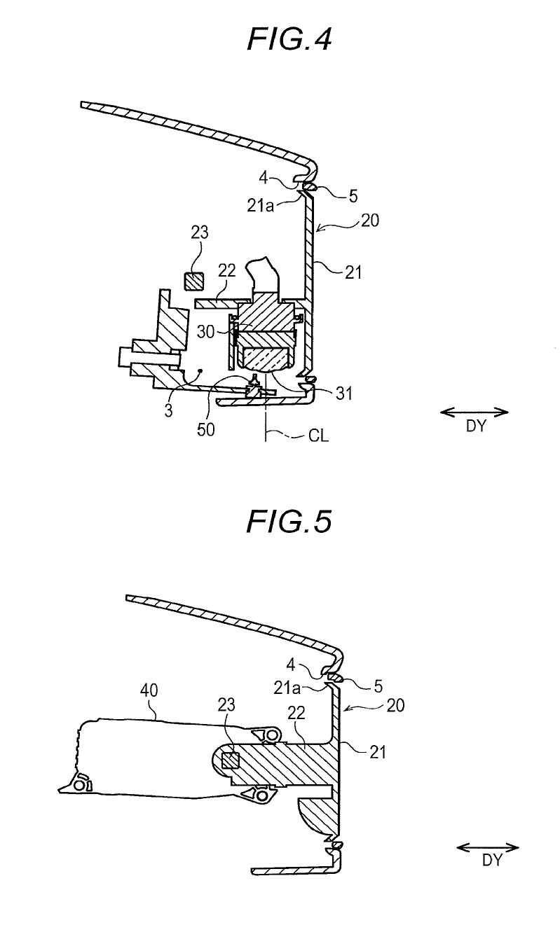

The camera 30 rotates about a rotating shaft 23 (see FIG. 4) in the width direction DX. Further, the camera 30 is disposed such that an optical axis CL at a predetermined angle (e.g., 90 degrees) intersects a line in the width direction DX at any rotational position of the camera 30. The camera 30 is accommodated in a camera accommodation chamber 3 provided in the vehicle 1.

For example, the camera accommodation chamber 3 is disposed at a central portion in the vehicle width direction in the rear portion of the vehicle 1. For example, the camera accommodation chamber 3 is provided at the back side of an emblem on a rear door 2 (a hatchback door or a trunk door).

The camera accommodation chamber 3 includes an opening 4 that communicates with the exterior of the vehicle. A seal ring 5 is provided at a peripheral edge of the opening 4. The opening 4 is closed by the lid 20. An outer surface of the lid 20 may be decorated by a decorative member such as an emblem or a mark of the vehicle 1. The lid 20 covers the opening 4 of the camera accommodation chamber 3, thereby inhibiting water or dust from flowing into the camera accommodation chamber 3.

The lid 20 is rotatably mounted on the rear door 2. For example, the lid 20 rotates about the rotating shaft 23 (the same axis as the rotating shaft 23 of the camera 30 (see FIG. 4)) in the width direction DX. The rotating shaft 23 of the lid 20 and the rotating shaft 23 of the camera 30 are the common member. The rotating shaft 23 is mounted on the lid 20 through a bracket 22.

A structure for rotatably supporting the lid 20 on the opening 4 is configured such that when the lid 20 rotates about the rotating shaft 23, a part of a lid main body portion 21 enters the camera accommodation chamber 3 (see FIGS. 7 and 10). As a structure for rotatably supporting the lid 20 on the opening 4, for example, a structure in which the lid main body portion 21 is disposed outside the camera accommodation chamber 3 when the lid 20 is rotated (hereinafter, referred to as a “comparative structure”) may be implemented, and in this case, a rotation range of the lid 20 is restricted, or a radius of a rotation trajectory of the lid 20 is increased. In this respect, according to the configuration, that is, according to the structure in which a part of the lid main body portion 21 is accommodated in the camera accommodation chamber 3 when the lid 20 is rotated, a radius of a rotation trajectory of the lid 20 may be decreased and a range of a rotation angle of the lid 20 may be increased compared with the comparative structure.

As illustrated in FIGS. 4 and 5, the lid 20 includes the lid main body portion 21 that closes the opening 4, and the bracket 22 that protrudes from the lid main body portion 21.

A flange 21a, which protrudes toward the camera accommodation chamber 3, is provided at a peripheral edge of the lid main body portion 21. The flange 21a comes into contact with the seal ring 5 (e.g., O-ring), which is provided at the peripheral edge of the opening 4, from the inside of the opening 4. The bracket 22 protrudes from a central portion of the lid main body portion 21. The rotating shaft 23 is provided at an end portion of the bracket 22 (see FIG. 5). The rotating shaft 23 is connected directly to an output shaft of a motor which constitutes the driving device 40, or connected indirectly to the output shaft of the motor through a power transmission member such as gears. The camera 30 is mounted at a portion of the bracket 22 between the rotating shaft 23 and the lid main body portion 21. Specifically, the camera 30 is mounted on the bracket 22 so that the optical axis CL of the camera 30 is directed downward in a state in which the lid 20 closes the opening 4 of the camera accommodation chamber 3. This posture of the camera 30 corresponds to an “accommodation posture” to be described below. The bracket 22 is rotated by power of the driving device 40. That is, the camera 30 and the lid 20 are rotated together by an operation of the driving device 40.

As illustrated in FIG. 4, a cleaning member 50, which cleans a lens surface 31 of the camera 30, is disposed in the camera accommodation chamber 3. The lens surface 31 is an outer surface of an outermost lens (including a filter) in a lens system.

For example, the cleaning member 50 is configured by a rubber sheet or a fiber bundle having elasticity, and comes into contact with the lens surface 31 so as to remove foreign matters attached to the lens surface 31. The cleaning member 50 is disposed at a portion where the cleaning member 50 does not come into contact with the lens surface 31 of the camera 30 when the camera 30 is accommodated in the camera accommodation chamber 3 and disposed in the accommodation posture (see the following description).

Next, postures which may be assumed by the camera 30 will be described in detail.

The accommodation posture of the camera 30 will be described with reference to FIGS. 3 to 5. FIG. 3 is a front view of the vehicle camera device 10 when the camera 30 is disposed in the accommodation posture, FIG. 4 is a cross-sectional view taken along line IV-IV in FIG. 3, and FIG. 5 is a cross-sectional view taken along line V-V in FIG. 3.

The accommodation posture is a posture of the camera 30 when the camera 30 is accommodated in the camera accommodation chamber 3 and the opening 4 is closed by the lid 20.

When the camera 30 is disposed in the accommodation posture, the peripheral edge of the lid 20 comes into contact with the seal ring 5 in the opening 4, thereby sealing the opening 4. The lens surface 31 of the camera 30 is positioned closer to the opening 4 than the cleaning member 50, and does not come into contact with the cleaning member 50. Since the lens surface 31 is positioned closer to the opening 4 than the cleaning member 50, the lens surface 31 does not come into contact with the cleaning member 50 when the lid 20 is rotated to expose the camera 30. In addition, even when the lid 20 is rotated so that the camera 30 is disposed in the accommodation posture from a predetermined posture in which the camera 30 is exposed, the lens surface 31 does not come into contact with the cleaning member 50.

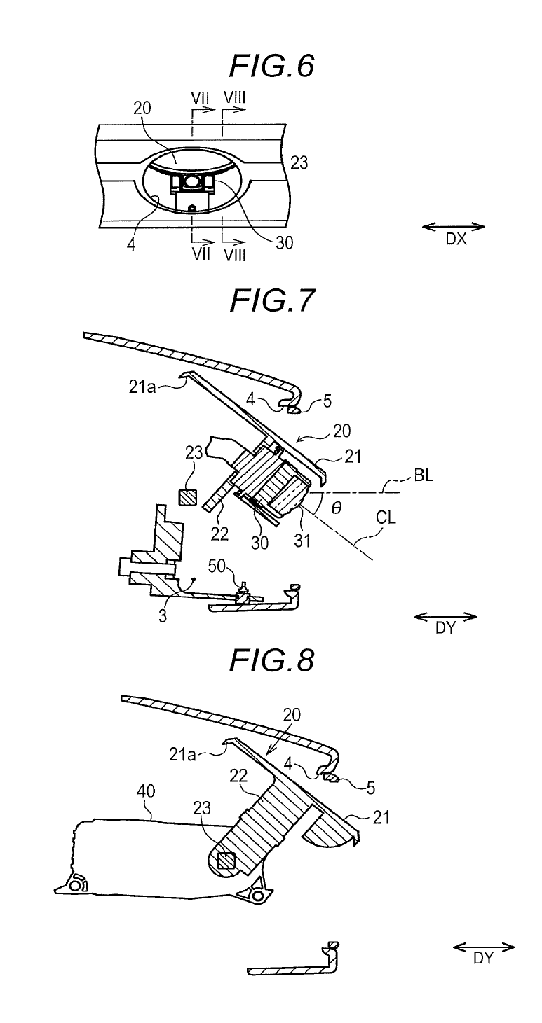

A first image capturing posture of the camera 30 will be described with reference to FIGS. 6 to 8. FIG. 6 is a front view of the vehicle camera device 10 when the camera 30 is disposed in the first image capturing posture, FIG. 7 is a cross-sectional view taken along line VII-VII in FIG. 6, and FIG. 8 is a cross-sectional view taken along line VIII-VIII in FIG. 6. The first image capturing posture is a posture in which the camera 30 captures an image of an obliquely lower side of the vehicle 1.

When the camera 30 shifts to the first image capturing posture from the accommodation posture, the lid 20 is rotated so that an upper portion of the lid main body portion 21 enters the camera accommodation chamber 3, and as a result, the opening 4 is opened. The camera 30 is exposed from the opening 4, and the optical axis CL of the camera 30 is tilted at a predetermined angle (an angle θ that is equal to or larger than 10 degrees and smaller than 90 degrees) downward from a reference axis BL (an axis in the front and rear direction DY (the same applies hereinafter)). The angle, that is, the angle of the optical axis CL of the camera 30 with respect to the reference axis BL is set such that an image of a road surface at a rear periphery of the vehicle 1 is captured by the camera 30.

The first image capturing posture of the camera 30 is a posture which may be assumed by the camera 30 when the vehicle 1 moves rearward. The information about images, which are captured by the camera 30 when the vehicle 1 moves rearward, is displayed on the display device in the vicinity of a driver seat. Therefore, the driver may recognize the existence and non-existence of an obstacle on a road surface at the rear side of the vehicle 1, parking lines, or the like.

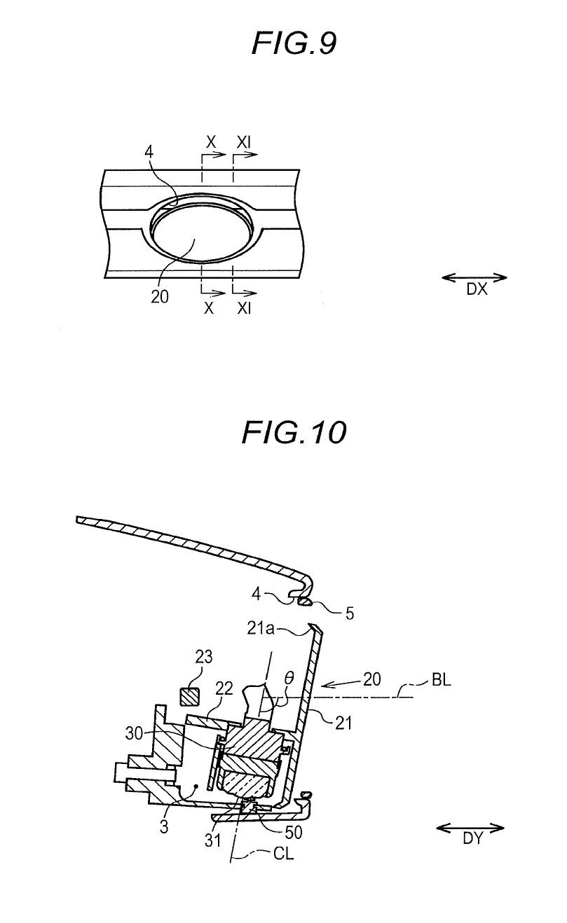

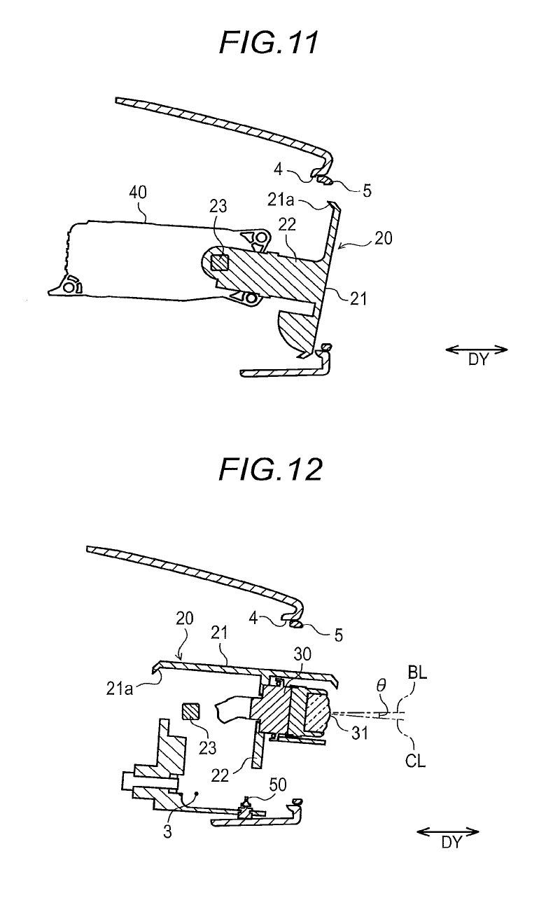

A cleaning posture of the camera 30 will be described with reference to FIGS. 9 to 11. FIG. 9 is a front view of the vehicle camera device 10 when the camera 30 is disposed in the cleaning posture, FIG. 10 is a cross-sectional view taken along line X-X in FIG. 9, and FIG. 11 is a cross-sectional view taken along line XI-XI in FIG. 9. The cleaning posture is a posture of the camera 30 when cleaning the lens surface 31.

When the camera 30 shifts to the cleaning posture from the accommodation posture, the lid 20 is rotated (rotated in a direction opposite to a direction in which the camera 30 shifts to the first image capturing posture from the accommodation posture) so that a lower portion of the lid main body portion 21 enters the camera accommodation chamber 3, and as a result, the opening 4 is opened. The optical axis CL of the camera 30 is tilted at a predetermined angle (an angle θ larger than 90 degrees) downward from the reference axis BL. This angle θ, that is, the angle θ of the optical axis CL of the camera 30 with respect to the reference axis BL is set such that the lens surface 31 comes into contact with the cleaning member 50. That is, in the cleaning posture, the lens surface 31 of the camera 30 comes into contact with the cleaning member 50.

A cleaning process of cleaning the lens surface 31 will be described. When performing the cleaning process, the camera 30 is disposed in the cleaning posture. During the cleaning process, the camera 30 in the cleaning posture reciprocally moves in a predetermined angle range. Therefore, foreign matters attached to the lens surface 31 are removed. For example, the cleaning process is performed at predetermined timing (e.g., once a day), and as described below, the cleaning process is performed based on a cleaning command, or performed based on detection of foreign matter attachment.

A second image capturing posture of the camera 30 will be described with reference to FIG. 12.

When the camera 30 shifts to the second image capturing posture from the accommodation posture, the lid 20 is rotated until the upper portion of the lid main body portion 21 enters the camera accommodation chamber 3 and the outer surface of the lid main body portion 21 becomes parallel to the reference axis BL, and as a result, the opening 4 is opened. The camera 30 is exposed from the opening 4, and the optical axis CL of the camera 30 becomes parallel to the reference axis BL or the angle θ formed with the reference axis BL becomes a predetermined angle (e.g., an angle smaller than 10 degrees).

The second image capturing posture of the camera 30 is a posture which may be assumed by the camera 30 when the vehicle 1 travels or when the vehicle 1 moves rearward. The information about images, which are captured by the camera 30 when the vehicle 1 travels, is displayed on the display device at the driver seat. Therefore, the driver may recognize a distance between the vehicle 1 and a following vehicle (i.e., a “distance between vehicles”). Similarly, the information about images, which are captured by the camera 30 when the vehicle 1 moves rearward, is displayed on the display device in the vicinity of a driver seat. Therefore, the driver may recognize a distance between the vehicle 1 and an obstacle at the rear side of the vehicle 1.

When the vehicle 1 travels and the camera 30 is disposed in the second image capturing posture, the distance between vehicles may be calculated. That is, a distance between the vehicle 1 having the vehicle camera device 10 and a following vehicle (i.e., a “distance between vehicles”) is calculated based on an image of the camera 30. The distance between vehicles may be used as information for allowing the driver to determine whether a following vehicle approaches the vehicle 1.

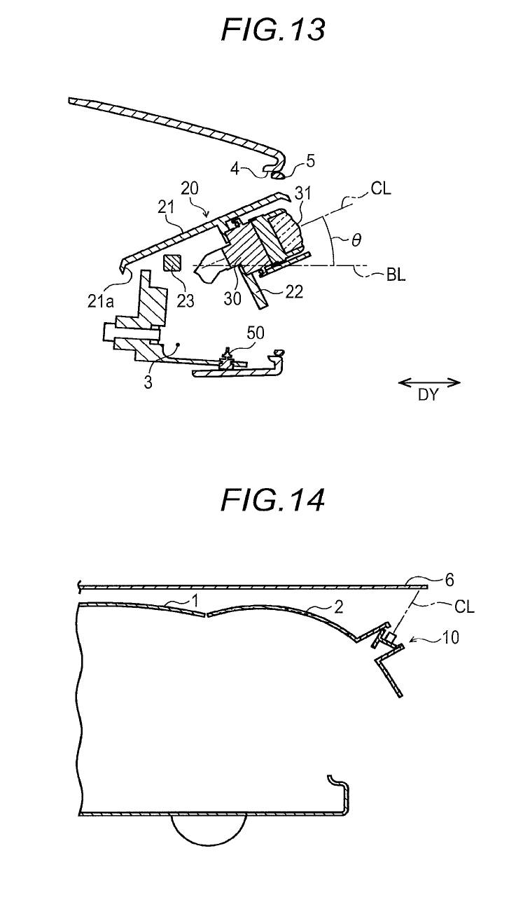

A third image capturing posture of the camera 30 will be described with reference to FIG. 13.

When the camera 30 shifts to the third image capturing posture from the accommodation posture, the lid main body portion 21 enters the camera accommodation chamber 3, and the lid main body portion 21 is rotated so as to be directed upward. The camera 30 is exposed from the opening 4. The optical axis CL of the camera 30 is tilted at a predetermined angle (an angle equal to or larger than 10 degrees and smaller than 90 degrees) upward from the reference axis BL. For example, the angle, that is, the angle θ of the optical axis CL of the camera 30 with respect to the reference axis BL is set to an angle at which the camera 30 may capture an image of an obstacle 6 (e.g., a ceiling of a garage) that may be disposed at the upper side of the vehicle 1 in a state in which the rear door 2 is opened in half (in a state in which the rear door 2 is opened at an angle half of an angle when the rear door 2 is maximally opened).

The third image capturing posture of the camera 30 is a posture which may be assumed by the camera 30 when the rear door 2 is opened. Information of images captured by the camera 30 when the rear door 2 is opened may be used to calculate a distance between the rear door 2 and the obstacle 6 (e.g., a ceiling of a garage) at the upper side of the rear door 2. The distance, which is calculated as described above, is used to output an alarm about collision avoidance or a collision between the rear door 2 and the obstacle 6. For example, an alarm may be outputted or a rotation of the rear door 2 may be restricted based on a situation in which a distance between the rear door 2 and the obstacle becomes equal to or smaller than a predetermined distance.

For example, the camera 30 is disposed in the third image capturing posture at the following timing. That is, the camera 30 is disposed in the third image capturing posture based on an operation of opening the rear door 2 (e.g., an operation of unlocking the rear door 2 or rotating the rear door 2).

When the camera 30 is disposed in the third image capturing posture, an image of a state in which the rear door 2 approaches the obstacle 6 at the upper side of the rear door 2 may be captured by the camera 30. In particular, in the third image capturing posture, an image of the rear door 2 and an image of the obstacle 6 at the upper side of the rear door 2 may be captured at an earlier stage (i.e., at a stage before a rotation angle of the rear door 2 is increased) than the second image capturing posture. Further, the camera 30 sequentially calculates a separation distance between the rear door 2 and the obstacle 6 based on image capturing information, and determines whether the separation distance becomes equal to or smaller than a predetermined distance. The separation distance between the rear door 2 and the obstacle 6 is a distance between the obstacle 6 and a portion of the rear door 2 which is expected to collide with the obstacle 6 by the rotation of the rear door 2. When the separation distance becomes equal to or smaller than a predetermined distance, the camera 30 outputs alarm sound. Therefore, it is possible to warn a person, who opens the rear door 2, that there is concern that the rear door 2 will collide with the obstacle 6.

Next, an operation and an effect of the vehicle camera device 10 will be described.

(1) The camera 30 of the vehicle camera device 10 has the first image capturing posture when the camera 30 captures an image of a portion below the reference axis BL (an axis in the front and rear direction DY), the accommodation posture when the camera 30 is accommodated in the camera accommodation chamber 3, and the other postures. As described above, the vehicle camera device 10 has its use in addition to the function of capturing an image of a portion below the reference axis BL, thereby improving the convenience of the vehicle camera device 10.

(2) The camera 30 may have the second image capturing posture for capturing an image of a portion in the reference axis BL as a posture different from the first image capturing posture. With the configuration, it is possible to provide image information that enables the driver to recognize a following vehicle or an obstacle at the rear side of the vehicle.

The camera 30 may have the third image capturing posture for capturing an image of a portion above the reference axis BL as a posture different from the first image capturing posture. With the configuration, it is possible to provide image information that enables the driver to recognize the obstacle 6 at the upper side of the vehicle 1.

(3) As the rear door 2 is opened, the camera 30 is disposed in the third image capturing posture. With the configuration, an image of the obstacle 6 disposed at the upper side of the rear door 2 is captured. For example, information about the captured images may be used to calculate a distance between the rear door 2 and the obstacle 6.

(4) The vehicle camera device 10 may have the cleaning member 50 that cleans the camera 30. The cleaning member 50 is disposed at a portion where the lens surface 31 of the camera 30 does not come into contact with the cleaning member 50 when the camera 30 is disposed in the accommodation posture. Further, the camera 30 may be disposed in the cleaning posture in which the lens surface 31 may be cleaned as the lens surface 31 comes into contact with the cleaning member 50. With the configuration, the camera 30 is disposed in the cleaning posture, and the lens surface 31 is cleaned. For this reason, the contact frequency between the cleaning member 50 and the lens surface 31 is decreased compared with a structure in which the lens surface 31 comes into contact with the cleaning member 50 when the camera 30 is disposed in the accommodation posture, and as a result, the deterioration of the lens surface 31 due to the aforementioned contact is inhibited.

(5) The camera 30 shifts to the cleaning posture at predetermined timing, based on a cleaning command for cleaning the lens surface 31 of the camera 30, or detection of foreign matters attached to the lens surface 31 of the camera 30. Further, the camera 30 reciprocally moves. With the configuration, the cleaning member 50 reciprocally moves on the lens surface 31, and as a result, it is possible to inhibit foreign matters from remaining on the lens surface 31 compared with a case in which the camera 30 does not reciprocally move.

### Another Exemplary Embodiment

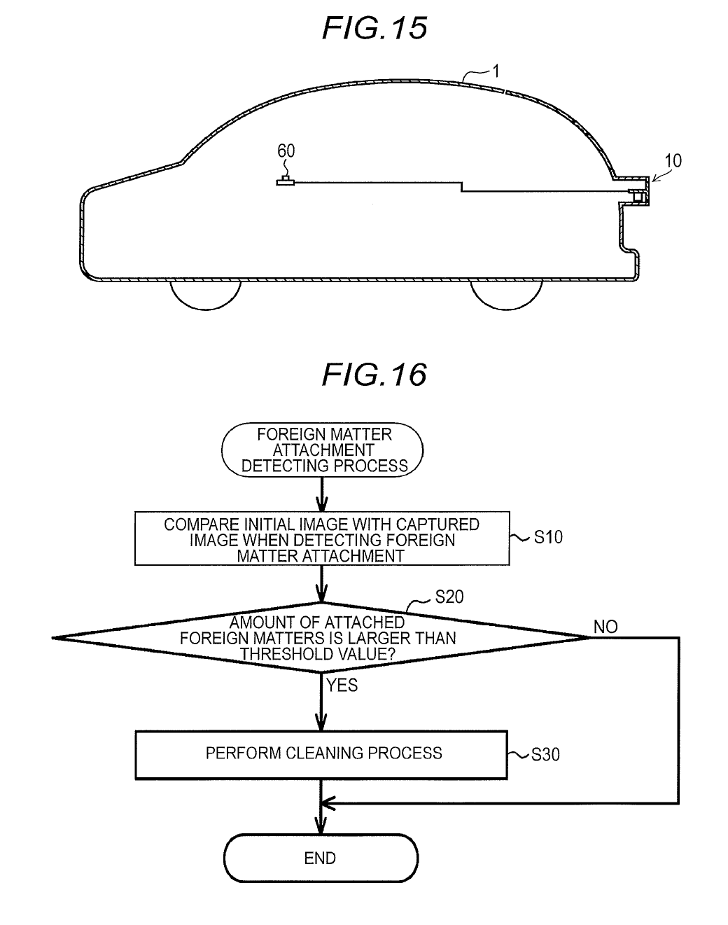

Regarding a condition for performing a cleaning process on the vehicle camera device 10, another example will be described with reference to FIG. 15. An image captured by the camera 30 is displayed on the display device. For this reason, a user may recognize foreign matter attachment from the image displayed on the display device. In this case, the user wants to remove the foreign matters from the lens surface 31. For this reason, it is possible to remove the foreign matters in accordance with the user's intention. Therefore, an operating device 60, which transmits a command based on an operation, may be disposed in the vicinity of the drive seat. The operating device 60 has an operating switch (a movable switch, a contact switch, or a non-contact switch), and outputs a command to the driving device 40 by an operation of the switch. The driving device 40 performs the aforementioned cleaning process based on the command.

That is, in the vehicle camera device 10, based on the command transmitted by the operating device 60, the camera 30 shifts to the cleaning posture and reciprocally moves to move a contact portion of the cleaning member 50 on the lens surface 31. With the configuration, the lens surface 31 of the camera 30 is cleaned based on an operation of the operating device 60.

Regarding a condition for performing a cleaning process on the vehicle camera device 10, still another example will be described with reference to FIG. 16. Foreign matters attached to the camera 30 need to be removed early. The reason is that in the case of an image captured in a state in which foreign matters are attached, it is difficult to recognize an object from the captured image (i.e., visibility through the camera 30 is restricted) and precision of a calculated value deteriorates when a distance from an obstacle or a following vehicle is calculated based on the captured image. Therefore, the camera 30 may have a function (referred to as a “foreign matter attachment detecting function”) for detecting foreign matter attachment based on the captured image. The foreign matter attachment detecting function is configured as a function based on a “foreign matter attachment detecting process” performed by the camera 30.

A foreign matter attachment detecting process will be described with reference to FIG. 16. The foreign matter attachment detecting process includes the following steps. Further, the foreign matter attachment detecting process is performed by the camera 30 itself (e.g., a control device included in the camera 30).

In step S10, the camera 30 compares an initial image with a captured image when detecting the foreign matter attachment, and calculates a difference between the initial image and the captured image. For example, the initial image is an image captured by the camera 30 when the camera 30 is in the accommodation posture at a predetermined timing (e.g., when the vehicle camera device 10 is mounted in the vehicle 1). The captured image is registered on a recording device of the camera 30. For example, a timing for detecting the foreign matter attachment is set to a timing when the camera 30 shifts to the accommodation posture from a posture in which the camera 30 is exposed. The reason why the timing for detecting the foreign matter attachment is set to the aforementioned timing is that there is a great likelihood that the foreign matters will be attached when the camera 30 is exposed.

The greater the difference between the initial image and the captured image when detecting the foreign matter attachment, the greater the likelihood that the foreign matters will be attached, and as a result, the difference is defined as the “amount of attached foreign matters”. Further, the difference between the initial image and the captured image when detecting the foreign matter attachment is calculated by various methods, and for example, the difference may be calculated as the total sum of differences in lightness between pixels that constitute the image.

In step S20, the camera 30 determines whether the amount of attached foreign matters is larger than a predetermined threshold value. When the amount of attached foreign matters is larger than the predetermined threshold value, the camera 30 determines that foreign matters are attached to the lens surface 31. In the case of this determination (YES determination), the process proceeds to step S30, and the aforementioned cleaning process is performed. That is, based on the detection of the foreign matter attachment, the camera 30 shifts to the cleaning posture and reciprocally moves. Meanwhile, when the amount of attached foreign matters is equal to or smaller than the predetermined threshold value (NO determination), the foreign matter attachment detecting process ends.

When the foreign matter attachment is detected, the aforementioned configuration, that is, the camera 30 shifts to the cleaning posture and reciprocally moves, thereby moving a contact portion of the cleaning member 50 on the lens surface 31. With the configuration, the lens surface 31 is cleaned based on the detection of the foreign matter attachment, and as a result, it is possible to shorten the time for which the camera 30 is maintained in a state in which the foreign matters are attached to the lens surface 31.

In the exemplary embodiment, the camera 30 is mounted on the lid 20, and the camera 30 and the lid 20 are operated by the same operating system, but the camera 30 may be operated independently of the lid 20. For example, an operating system for operating the camera 30 (a second operating system of the driving device 40) may be provided separately from an operating system for operating the lid 20 (a first operating system of the driving device 40). With the configuration, it is possible to clean the lens surface 31 by operating the camera 30 in a state in which the opening 4 of the camera accommodation chamber 3 is closed by the lid 20.

(1) A vehicle camera device according to an aspect of this disclosure includes: a lid that opens and closes an opening of a camera accommodation chamber; a camera that is capable of being accommodated in the camera accommodation chamber and exposed from the opening when the opening is opened by a rotation of the lid; and a driving device that operates the camera and the lid, in which the camera has an image capturing posture when the camera captures an image of a portion below a reference axis, an accommodation posture when the camera is accommodated in the camera accommodation chamber, and the other postures different from the image capturing posture and the accommodation posture. As described above, the vehicle camera device has its use in addition to the function of capturing an image of a portion below the reference axis, thereby improving the convenience of the vehicle camera device.

(2) In the vehicle camera device, as the other postures, the camera may have at least one of a second image capturing posture for capturing an image in a direction along the reference axis, and a third image capturing posture for capturing an image of a portion above the reference axis, separately from a first image capturing posture which is the image capturing posture.

(3) In the vehicle camera device, the camera may have the third image capturing posture as the other posture, and be mounted on a rear door of a vehicle and disposed in the third image capturing posture when the rear door is opened. With this configuration, an image of an obstacle disposed at an upper side of the rear door is captured.

(4) The vehicle camera device may further include a cleaning member that cleans the camera, in which the cleaning member may be disposed at a portion where a lens surface of the camera does not come into contact with the cleaning member when the camera is disposed in the accommodation posture in the camera accommodation chamber that accommodates the camera, and the camera may further have a cleaning posture in which the lens surface comes into contact with the cleaning member such that the lens surface is cleaned. With this configuration, the camera is disposed in the cleaning posture, and the lens surface is cleaned. For this reason, the frequency of the contact between the cleaning member and the lens surface is decreased compared with a structure in which the lens surface comes into contact with the cleaning member when the camera is disposed in the accommodation posture, and as a result, the deterioration of the lens surface due to the aforementioned contact is inhibited.

(5) In the vehicle camera device, the camera may shift to the cleaning posture and reciprocally move based on a predetermined timing, based on a cleaning command for cleaning the lens surface of the camera, or based on detection of foreign matters attached to the lens surface of the camera. With this configuration, the cleaning member reciprocally moves on the lens surface, and as a result, it is possible to inhibit foreign matters from remaining on the lens surface in comparison with a case in which the camera does not reciprocally move.

(6) The vehicle camera device may further include an operating device that transmits a command based on an operation, in which based on the command transmitted from the operating device, the camera may shift to the cleaning posture and reciprocally moves to move a contact portion of the cleaning member on the lens surface. With this configuration, the lens surface of the camera is cleaned based on an operation of the operating device.

(7) In the vehicle camera device, the camera may have a foreign matter attachment detecting function for detecting foreign matter attachment, and when detecting the foreign matter attachment by the foreign matter attachment detecting function, the camera may shift to the cleaning posture and reciprocally moves to move a contact portion of the cleaning member on the lens surface. With this configuration, the lens surface is cleaned based on the detection of the foreign matter attachment, and as a result, it is possible to shorten the time for which the camera is maintained in a state in which the foreign matters are attached to the lens surface.

The vehicle camera device has its use in addition to the function of capturing an image of a portion below the reference axis, thereby having a high convenience.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle camera device comprising:
a lid that opens and closes an opening of a camera accommodation chamber;
a camera that is capable of being accommodated in the camera accommodation chamber and exposed from the opening when the opening is opened by a rotation of the lid; and
a driving device that operates the camera and the lid,
wherein the camera has an image capturing posture when the camera captures an image of a portion below a reference axis, an accommodation posture when the camera is accommodated in the camera accommodation chamber, and the other postures different from the image capturing posture and the accommodation posture.

2. The vehicle camera device according to claim 1, wherein as the other postures, the camera has at least one of a second image capturing posture for capturing an image in a direction along the reference axis, and a third image capturing posture for capturing an image of a portion above the reference axis, separately from a first image capturing posture which is the image capturing posture.

3. The vehicle camera device according to claim 2, wherein the camera has the third image capturing posture as the other postures, and is mounted on a rear door of a vehicle and disposed in the third image capturing posture when the rear door is opened.

4. The vehicle camera device according to claim 1, further comprising:
a cleaning member that cleans the camera,
wherein the cleaning member is disposed at a portion where a lens surface of the camera does not come into contact with the cleaning member when the camera is disposed in the accommodation posture in the camera accommodation chamber that accommodates the camera, and the camera further has a cleaning posture in which the lens surface comes into contact with the cleaning member such that the lens surface is cleaned.

5. The vehicle camera device according to claim 4,
wherein the camera shifts to the cleaning posture and reciprocally moves based on a predetermined timing, based on a cleaning command for cleaning the lens surface of the camera, or based on detection of foreign matters attached to the lens surface of the camera.

6. The vehicle camera device according to claim 4, further comprising:
an operating device that transmits a command based on an operation,
wherein based on the command transmitted from the operating device, the camera shifts to the cleaning posture and reciprocally moves to move a contact portion of the cleaning member on the lens surface.

7. The vehicle camera device according to claim 4,
wherein the camera has a foreign matter attachment detecting function for detecting foreign matter attachment, and when detecting the foreign matter attachment by the foreign matter attachment detecting function, the camera shifts to the cleaning posture and reciprocally moves to move a contact portion of the cleaning member on the lens surface.
